(19) United States
(12) Patent Application Publication
(10) Pub. No.: US 2004/0013241 A1
(43) Pub. Date: Jan. 22, 2004

(54) Communications system with automatic notification of a subscriber in the event of a functional degradation of a subscriber line

(76) Inventor: Michael Zwach, Moedling (AT)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/418,246

(22) Filed: Apr. 18, 2003

(30) Foreign Application Priority Data
Apr. 26, 2002 (EP) 02 009 547.7

(51) Int. Cl. H04M 1/24; H04M 3/22

(52) U.S. Cl. 379/32.01; 379/32.04; 379/28; 379/27.03

(57) ABSTRACT

The present invention includes a method for operating a communications system, wherein a telecommunications network provides a transmission channel in order to transfer a message between connected subscribers. The method includes the following steps: monitor the functional reliability of a first subscriber line connected to a switching station; generate a fault message if this subscriber line is not functionally reliable; and transmit this fault message to a second subscriber.

### CONTINUATION DATA

The present invention claims priority to European patent application 02009547.7, filed Apr. 26, 2002, which is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

A communications system serves the specific purpose of transferring or exchanging information. In a public telecommunications network, information is transmitted over subscriber lines to switching processors that provide transmission paths in a network. A functionally reliable subscriber line is the prerequisite for using the services and service features of the network. Reliable message transmission only comes about if the terminal equipment, the subscriber lines and the network satisfy the imposed requirements.

Various test measures, such as real-time monitoring, routine and ad hoc tests, are known for detecting, diagnosing and isolating faults in telephone networks. If, for example, routine tests are performed weekly in a network, only about 10% of faults are registered. In 90% of cases, the service personnel of the network provider learn of actual or suspected defects only as a result of customer complaints. Up to 24 hours—in extreme cases even longer—can then have elapsed between the occurrence of a fault and its recovery. Increasingly heavy demands are being made on network availability in telephone networks, however.

With analog lines, a line break can be detected by a concentrator by means of a continuous tone transmitted in the non-audible range. However, the analog telephone network currently finds itself in a state of continuous transition to the entirely digital telephone network. In order to be able to test a subscriber line in the case of digital lines as well, cyclical messages are transmitted in the message or control channel.

In order to achieve the highest possible network availability, test functionalities are increasingly being relocated to the switching centers (exchanges) of the network, which monitor subscriber lines locally.

Network availability can be improved considerably by means of an automatic test that is executed, for example, every five minutes. The functionality for performing the tests is integrated in the switching processor and assigned to the individual subscriber line modules. By means of an integrated subscriber line test of this type, both analog and digital lines can be efficiently monitored. In the event of a fault, an extended test program can be activated, thereby enabling the fault to be isolated. Thanks to this test functionality, the maintenance personnel of the network provider obtain detailed information about the failure of the network-internal module. In most cases it is possible to rectify the fault very quickly, often so quickly that the subscriber concerned notices nothing whatsoever about it.

In addition to voice transmission, however, data for monitoring and controlling physically remote subscriber terminal equipment can also be transmitted through the telephone network.

Particularly severe reliability requirements are to be applied to security system equipment in which an alarm message is transmitted via the telecommunications network. An alarm must reach a central control center not only reliably but also quickly. A practical example is a fire alarm system, wherein a fire alarm must be reported reliably and quickly to the fire department or a fire protection unit. A further example is an intrusion alarm system that sends an alarm to a security service over the telephone line. In both cases it is crucial that the message is transferred reliably and swiftly to the recipient. An added factor with intrusion alarm systems is that not only do technical malfunctions need to be taken into account, but the transmission path is also exposed to attacks aimed specifically at paralyzing the security system. A crucial factor here is that there is a high probability that the communications system will be found to be in a functionally reliable state at the time of the event that triggers the alarm.

WO 98/09420 discloses a method for monitoring lines of an ISDN telecommunications network in which each subscriber line to be monitored is equipped with a response station that receives messages from a test station and can issue messages to this test station. At the instigation of an operator, the test station sets up a normal communications connection via the switched network to a response station with the terminal device to be checked. As a result, the response station is placed in a monitoring state in which it mirrors all D channel information to the test station. From this information, the test station generates a test log which it forwards to the maintenance personnel.

EP 0 939 944 proposes a method for monitoring a remote terminal system, such as e.g. a security alarm system, wherein a digital message channel is used between the central station and the system to be monitored at a remote location.

The polled response is encrypted, thus enabling the polling message to be authenticated at the central station. In this way not only the availability but also the integrity of the system is verified.

These known methods have the disadvantage that the monitoring is initiated from outside. In other words, an often long-range communications connection is periodically set up between the monitoring system and the system to be monitored. The subscriber terminal equipment must be designed accordingly for this. This is technically complicated and the transmission of the test message makes the initiator liable to bear the costs.

### SUMMARY OF THE INVENTION

An advantage of the invention is to improve the availability of a transmission channel between an alarm capture unit and a geographically remote alarm capture control center.

A method according to the invention for operating a communications system, wherein a telecommunications network provides a transmission channel in order to transfer a message between connected subscribers, comprises the following steps:

Monitor the functional reliability of a first subscriber line connected to a switching station;

Generate a fault message if this subscriber line is not functionally reliable;

Transmit this fault message to a second subscriber.

The invention is based on the idea that a fault message is transmitted to a subscriber if a malfunction is detected on the network side in a transmission channel that is to be monitored. In the case of switching equipment that periodically performs a subscriber line test, the information about a malfunction that has occurred is already available. The fault message is transmitted automatically and is event-driven. The information about the presence of a fault is the result of a monitoring operation that takes place in the network. In the event of a fault, the switching processor of the network automatically initiates the connection setup to the subscriber to be notified. As a result of the network-side fault recording, a fault message can then also be transmitted to an alarm receiving center if the connection to an alarm sending device is interrupted or the communications terminal equipment is defective. A residual functionality is not required in the alarm sending device. A cyclical polling procedure, by means of which an alarm control center checks the functional reliability of the connection to an alarm sending device, is not necessary. Thus, fault handling measures can be initiated promptly in the alarm receiving center. The failure of a transmission channel is recorded at an early stage and can be reported immediately. This opens up the possibility of also making provision in the alarm control center for a situation in which an alarm is possibly waiting to be processed but cannot be forwarded. In other words, the invention makes it possible to increase the probability that the alarm system will be found in a functionally reliable state at the time of an event that activates an alarm.

The fault message is preferably generated in a monitoring device of a switching station, said monitoring device being assigned to a subscriber line module. In this case the invention advantageously uses devices that are already present in switching centers of the network for the purpose of monitoring analog and digital subscriber lines. Only a small amount of overhead is required to configure these switched systems in such a way that, in the event of a fault, a connected subscriber is notified instead of the operator, i.e. the maintenance personnel of the network provider. As a result of the decentralized arrangement of the test devices, time-consuming administration overhead in the network is eliminated. Compared with the monitoring procedure initiated by a subscriber terminal equipment, the information about the presence of a fault reaches the alarm control center more quickly and results in lower costs.

It is advantageous if this monitoring device launches a test program in the switching center in selectable cycles in order to test the functional reliability of a subscriber line. As a result of the continual test operation, occurring faults can be swiftly detected and localized. The test can therefore be performed for different lines with different weightings.

It is particularly advantageous here if the test program performs a periodic check of the line parameters. This permits a detailed fault diagnosis.

It is advantageous if test results are compared with a selectable threshold value and if the transmission of the fault message is initiated if the results exceed or fall below the threshold value. The comparison with a selectable threshold value enables known local particularities of the line to be taken into account.

It is particularly advantageous if a predeterminable number of test results are recorded in a storage facility implemented as a history file and if this is transmitted to the second subscriber together with the fault message. In this way it is also possible to transmit information about the quality of a subscriber line to an alarm control center before a fault occurs. In this way, a validity check can be carried out in the alarm receiving center and transient malfunctions, caused, for example, by a thunderstorm, can be subjected to selective fault handling and assessment.

In a preferred embodiment, wherein the transmission channel is implemented at least in sections as an ISDN network, the fault message is transmitted in the signaling channel, i.e. the D channel of the ISDN network. The ISDN line can be tested simply by means of a check on whether it can be activated. With this procedure, no messages are exchanged. Instead, the control signals are represented by specific states of the interface line.

A telecommunications network according to the invention comprises a monitoring device for monitoring subscriber lines, said monitoring device being integrated in a switching center and set up in such a way that it transmits the occurrence of a malfunction on a first subscriber line to a second subscriber.

The monitoring device preferably comprises a testing device that checks the line parameters of subscriber lines and a reporting device that transmits a fault message to a second subscriber if the size of a tested line parameter exceeds or falls below a predefined threshold value.

In existing switching processors of a telecommunications system, recourse can advantageously be made to already implemented functionalities for realizing the invention, since both software and hardware functions for testing subscriber lines are already available. In a switching processor, an assignment between the line to be monitored and the address to which the fault message is to be routed can easily be entered in a database by the use of programming techniques. A number of lines can be monitored with different priorities. The test program is invoked more frequently for lines that are tagged as having a higher priority. As soon as the test program detects a fault on a line identified in this way, the assigned address of the alarm-receiving subscriber line is read out from the database. The switching processor initiates a D-channel message and transmits the subscriber data and possibly a description of the fault to this address. Faster fault localization is possible as a result. An alarm message is transmitted only when an alarm is actually waiting to be processed. If there is a fault in the transmission channel, on the other hand, a fault message is sent. An implicit check, such as cyclical polling of the alarm generator by a subscriber, is not required, since a failure of a connected subscriber terminal equipment or a line break is detected and recorded directly by the telecommunications network and forwarded.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a block diagram of an exemplary embodiment.

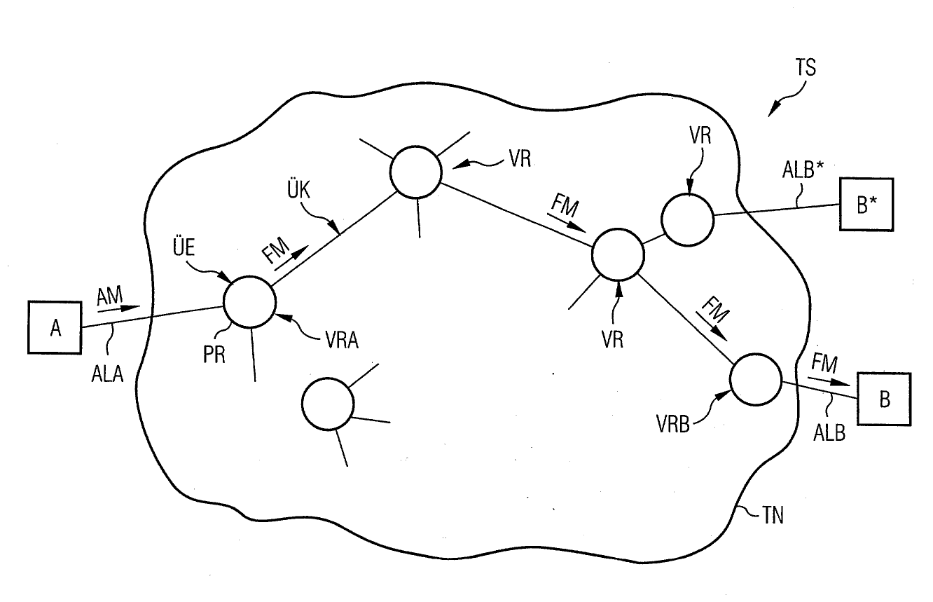

### DETAILED DESCRIPTION OF THE INVENTION

The telecommunications system TS represented in the FIGURE serves for the transmission of information between the first subscriber A and second subscriber B or B* connected to a telecommunications network TN. The invention is explained in the following with reference to a public digital ISDN telephone network TN as an example. A subscriber A, for example an alarm generator of a fire alarm system, is connected to a digital switching center VRA of the network TN via a subscriber line ALA. The switching center VRA is networked with further switching processors VR. The switching processors VR provide transmission channels in the network TN. In the schematic representation, a transmission channel ÜK is shown between the subscriber A and the subscriber B or B*. In the illustrated exemplary embodiment, the reference characters B and B* each identify an alarm evaluation facility, for example the alarm control center (B, B*) of a fire department unit which is assigned to the alarm generator A. In the fault-free state of the line ALA, an alarm message AM, which the alarm generator A sends into the network TN via the subscriber line ALA, can be transmitted via the illustrated transmission path ÜK in the network TN and via the subscriber line ALB to the alarm control center B. In an ISDN network, this alarm message AM can be transmitted over the B or D channel. If there is a fault on the subscriber line ALA, however, this fault is detected in the switching center VRA and, according to the invention, a fault message FM is transmitted externally. The initiative for transmitting the fault message FM to the subscriber B therefore originates in the network TN, since the current status of the line ALA is registered by the network-side test device PR. There is no need for a cyclical check of the connection path between the terminal devices A and B to be activated on the subscriber side. If there is a malfunction on the line ALA, this information can be forwarded practically instantaneously to the alarm control center B. Since in this way up-to-date information about the status of the connection to the alarm generator A is always available in the alarm control center B, suitable measures can be adopted in good time in the alarm control center B. This can be effected, for example, by switching over to another communications connection.

For a situation in which the switching processor VRB recognizes the subscriber line ALB as defective, the alarm message AM or the fault message FM can be rerouted on the network side via the subscriber line ALB* to the alarm control center B*.

In operationally deployed switching equipment of the type “Digital Electronic Switching System—EWSD” from Siemens, the system can be converted at comparatively little cost such that the transmission channel which connects security equipment attached to the network exhibits a high level of availability.

With these switching systems, the software can be modified with comparatively little effort such that a malfunction in a connected subscriber line is registered and reported externally to a control center assigned to the alarm generator. The hardware of the test device is already present at least partially in the switching system, since it is possible to use already integrated testing and metering functionality as a basis. This integrated testing and metering functionality is described, for example, in the Siemens company brochure “EWSD—Integrated Line Test Functions”.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

I claim:

1. A method for operating a communications system, said system comprising a telecommunications network which provides a transmission channel for transmitting an alarm message between subscribers, comprising the steps of:
monitoring functional reliability of a first subscriber line connected to a switching station;
generating a fault message if said first [SECOND?] subscriber line is not functionally reliable; and
transmitting said fault message to a second subscriber.

2. The method according to claim 1, wherein said step of generating further comprises the step of generating said fault message in a monitoring device of the switching station, said monitoring device being assigned to a subscriber line module.

3. The method according to claim 2, further comprising the steps of:
starting a test program via said monitoring device,
operating said program in selectable cycles, and
testing functional reliability of a subscriber line with said program.

4. The method according to claim 3, further comprising the step of periodically checking line parameters with said program.

5. The method according to claim 4, further comprises the steps of:
generating a result of said testing and periodically checking steps;
comparing said result with selected threshold value; and
initiating transmission of a fault message if said result exceeds or falls below said threshold value.

6. The method according to claim 5, further comprising the steps of:
recording a number of said results in a storage medium;
generating a file history of said results; and
transmitting said history and said fault message to said second subscriber.

7. The method according to claim 1, further comprising the steps of:
implementing said transmission channel in at least sections of an ISDN network; and
transmitting said fault message in a D channel of said ISDN network.

8. The method according to claim 1, wherein said telecommunications network is an integrated services digital telecommunications network and said step of monitoring is performed on a first subscriber line by means of a check on whether said line can be activated.

9. A telecommunications network including a plurality of subscribers and subscriber lines as well as a switching center, comprising:
a monitoring device, integrated in said switching center, for monitoring said subscriber lines such that an occurrence of a malfunction in a first subscriber line is transmitted to a subscriber.

10. The telecommunications network according to claim 9, wherein said monitoring device further comprises:
a testing device that checks line parameters of subscriber lines; and
a reporting device for transmitting a fault message to said subscriber if a size of a checked line parameter exceeds or falls below a predefined threshold value.

11. The telecommunications network according to claim 10, wherein said reporting device automatically establishes a connection to said subscriber.

12. The telecommunications system according to claim 9, wherein said connection to said second subscriber is an ISDN connection and said fault message is transmitted via an ISDN D channel.

13. A communications system, wherein a telecommunications network monitors a section of a transmission channel to a connected subscriber and, in an event of a fault, transmits a fault message to another subscriber.

14. The communications system according to claim 13, wherein said telecommunications system comprises:
a telecommunications network including a plurality of subscribers and subscriber lines as well as a switching center;
a monitoring device, integrated in said switching center, for monitoring said subscriber lines such that an occurrence of a malfunction in a first subscriber line is transmitted to a subscriber; and
a transmission channel between an alarm-sending and an alarm-receiving subscriber terminal equipment.
